(19) United States
(12) Patent Application Publication
(10) Pub. No.: US 2013/0299325 A1
(43) Pub. Date: Nov. 14, 2013

(54) "On - on master switch"

(71) Applicant: Andrew (Andrzej) Lewicki, Palatine, IL (US)

(72) Inventor: Andrew (Andrzej) Lewicki, Palatine, IL (US)

(73) Assignee: ANDREW (ANDRZEJ) LEWICKI, PALATINE, IL (US)

(21) Appl. No.: 13/506,785

(22) Filed: Dec. 1, 2012

Related U.S. Application Data
(60) Provisional application No. 61/520,159, filed on Jun. 6, 2011.

(51) Int. Cl. H01H 23/02

(52) U.S. Cl. CPC H01H 23/025
USPC 200/310

(57) ABSTRACT

I (the applicant) have invented a method of quarantine computer virus, cross reference to related application Ser. No. 61/520,159, filing or 371(c) date Jun. 4, 2011. The “ON-ON MASTER SWITCH” controls the electrical voltage (12 Volt and 5 Volt power) to the hard drives at different time. For home use one hard drive (the left side, red led) would be installed with operating program, internet, e-mail and skype. The other hard drive ( on the right side, green led) would be installed with operating programs, Microsoft office, adobe, adobe photo shop, Autocad, income tax files, photos, family moves, etc.

When you are surfing on the internet you can get a computer virus that will destroy your family photos, Autocad files etc. Or scan your computer and get your income tax files, banking information. With “ON-ON MASTER SWITCH” is on the left side your files are safe.

For business use one hard drive would be used as primary drive and the other one would be used as a secondary backup. If the primary drive has operating malfuation and has errors or computer lock up then secondary drive can be activated with “ON-ON MASTER SWITCH”. The down time is only a few minutes that a few hours.

### BACKGROUND OF THE INVENTION

The present invention relates generally to computer switches and more specifically it relates to a “on-on master switch” for a way to quarantine computer virus.

### BRIEF SUMMARY OF THE INVENTION

The invention generally relates to a computer switch which includes plastic computer panel, on-on miniature bat handle toggle, four and fifteen pin Molex power cable and two led lights one red and one green.

There has thus been outlined, rather broadly, some of the features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

The object is to provide a “On-On Master Switch” for a way to quarantine computer virus.

Another object is to provide a “On-On Master Switch” that will be used as another computer.

Another object is to provide a “On-On Master Switch” that will be used as a instant backup.

Another object is to provide a “On-On Master Switch” that will increase performance for business.

Another object is to provide a “On-On Master Switch” that will be used for upgrade computer software with approximately zero downtime for business.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1: Is a flowchart illustrating the overall operation of the present invention. Existing power conation with “On-On Master Switch”.

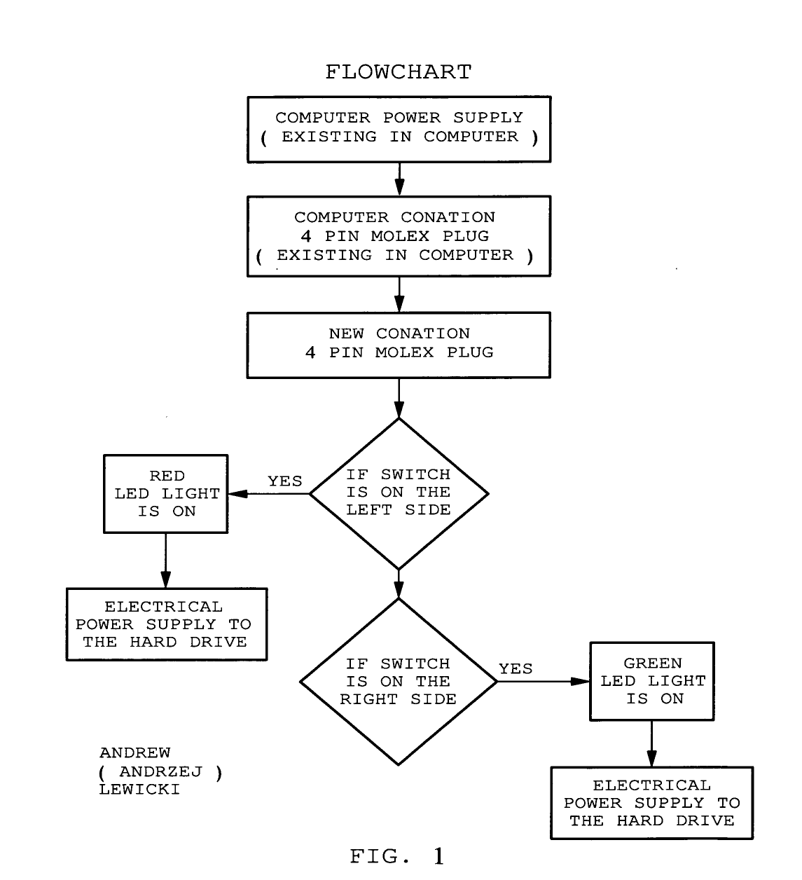

FIG. 2: Is an exploded upper perspective view of the present invention. Isometric illustration of component installation with back detail of on-on miniature bat handle toggle left, center and right terminal conations FIG. 2A.

FIG. 3: Is an alternative embodiment of the present invention. Single line components diagram.

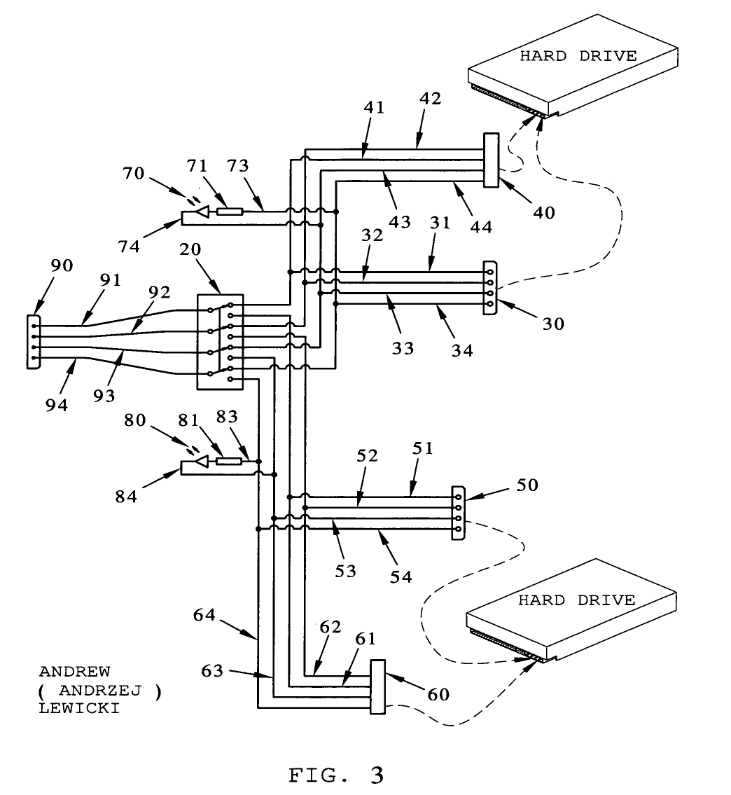

FIG. 4: Is a front view of the present invention, computer panel with dimensions.

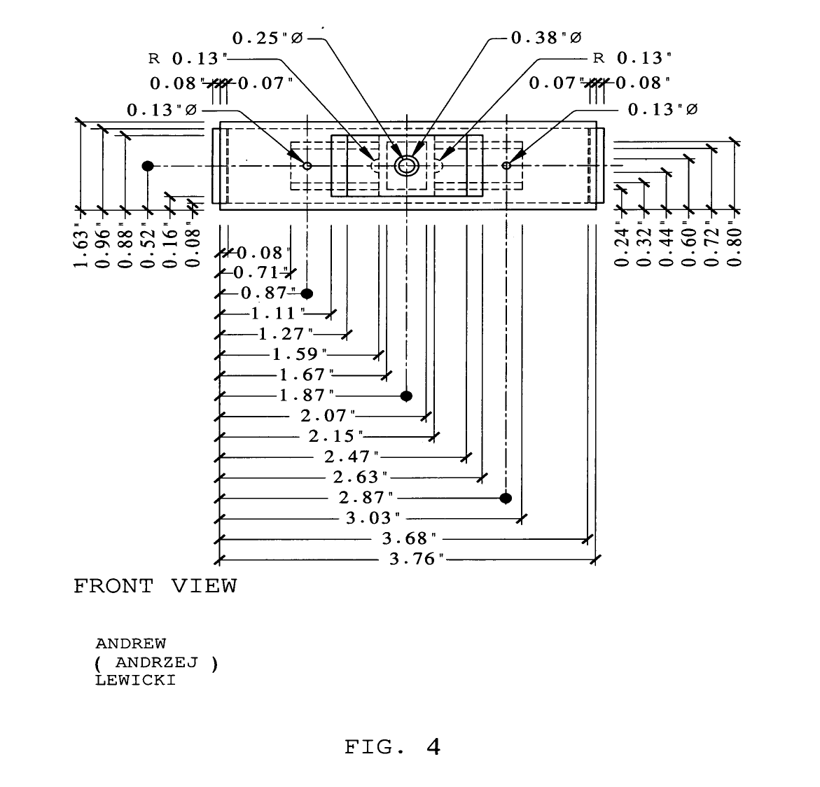

FIG. 5: Is a top view and view of the present invention, computer panel with dimensions.

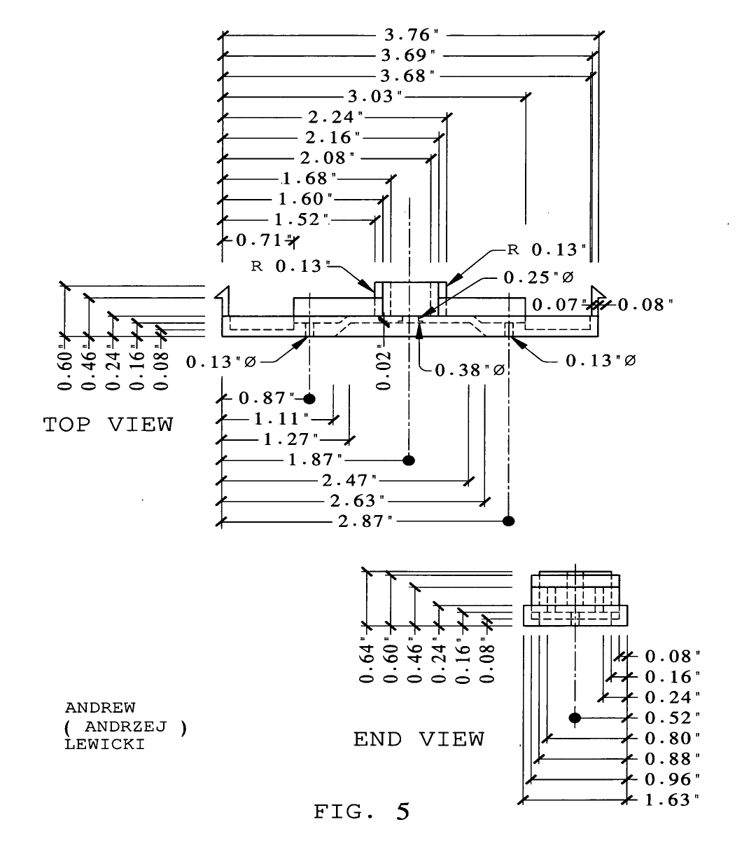

FIG. 6: Is a left side view of the present invention. Finished computer panel installed in a desk top computer.

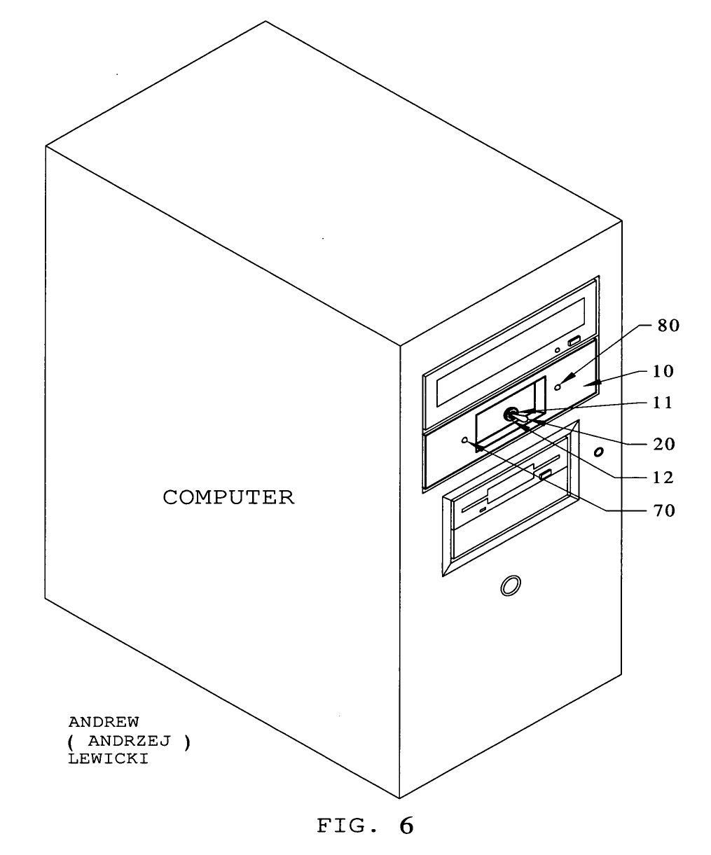

### DETAILED DESCRIPTION OF THE INVENTION

### A. Overview

Turning now descriptively to the drawings, in which similar reference characters denote similar elements throughout the several views, the figures illustrate plastic computer panel, on-on miniature bat handle toggle, four and fifteen pin Molex power cable and two led lights one red and one green.

### B. Plastic Computer Panel

The structure of the plastic computer panel (10) is to hold the components and to be installed into computer.

3.76 inches wide×1.63 inches high with two openings 0.13 inches diameter and one opening 0.38 inches diameter, which holds the components on-on miniature bat handle toggle switch and two led lights. When the components are installed in the plastic computer panel it is then installed with computer.

Provisional patent application did not have computer panel with new design.

### C. On-On Miniature Bat Handle Toggle

The structure of the on-on miniature bat handle toggle (20) is to switch from left to right when the computer is off. The function of on-on miniature bat handle toggle is to change the direction of electricity from one hard drive to another. Inside the computer there is power connections for hard drive, one power source can be used for connection with on-on miniature bat handle toggle (20).

Mini 4PDT (Four Pole Double Throw) on-on 125 Volt, 5 Amp, toggle switch, twelve (12) terminal. A switch device that open's, closes or changes connection of two conductors in an electrical circuit. Mounting hole 6 mm, material plastic, metal, silver. Dimension 12.8 mm×22.8 mm. There are twelve (12) terminal, four (4) in center, four (4) on the left side and four (4) on the right side.

Two (2) push button double pole switches can be used for one (1) on-on miniature bat handle toggle.

### D. Four Pin (Female) Molex Power Cable—Left Side

The structure is a plastic Molex four pin power cable. The function of the Molex power cable is to provide power source for the ATA or PATA hard drive, Molex (30) power cable.

Molex 8981, 21 mm width×6 mm height, as follows (1) yellow +12V, (2) black ground, and (1) red +5V. The pins are 0.200 inches (5.08 mm) apart (center to center). The connector housing has chamfered corners on one side to prevent the user from plugging it in incorrectly. The connector that provides power has female pins and male housing.

Right angle 90 degree 4-pin female Molex power cable can be used. It can do the same function.

### E. Fifteen Pin Molex Power Cable—Left Side

The structure is a plastic Molex fifteen pin power cable, only four pins are used. The function of the Molex power cable is to provide power source for the SATA or SSD hard drive, Molex (40) power cable.

It is 90 degree, dimension 60 mm×43 mm×43 mm×43 mm wafer-based, but its wider fifteen (15) pin shape prevents accidental mis-identification and forced insertion of the wrong connector type. Each voltage is transmitted through three grouped together, because the small contacts by themselves cannot supply sufficient current for some devices. A third voltage is supplied, 3.3V, in addition to the traditional 5V and 12V. Each voltage is transmitted through three pins. Five or six pins provide the ground connection, six being standard, or five if staggered spin-up or other special functionality is supported. For each of the three voltages, one of the three pins serves for hot-plugging. The ground pins and power pins 3, 7 and 13 are longer on the plug so they will connect fast. A special hot-plug receptacle can connect ground pins 4 and 12 first. Pin 11 can function for staggered spin-up, activity indication, both or nothing. It is an open collector signal that may be pulled down by the connector or the drive. If pulled down at the connector, the drive spins up as soon as power is applied. If left floating, the drive waits until it is spoken to, this prevents many drives from spinning up simultaneously, which might draw to much power. The pin is also pulled by the drive to indicate drive activity.

There are no alternative variations.

### F. Four Pin (Female) Molex Power Cable—Right Side

The structure is a plastic Molex four pin power cable. The function of the Molex power cable is to provide source for the ATA or PATA hard drive, Molex (50) power cable.

Molex 8981, 21 mm width×6 mm height, as follows (1) yellow +12V, (2) black ground, and (1) red +5V. The pins are 0.200 inches (5.08 mm) apart (center to center). The connector housing has chamfered corners on one side to prevent the user from plugging it in incorrectly. The connector that provides power has female pins and male housing.

Right angle 90 degree 4-pin female Molex power cable can be used. It can do the same function.

### G. Fifteen Pin Molex Power Cable—Right Side

The structure is a plastic Molex fifteen pin power cable, only for pins are used. The function of the Molex power cable is to provide power source for the SATA or SSD hard drive, Molex (60) power cable.

It is 90 degree, dimension 60 mm×43 mm×43 mm×43 mm wafer-based, but its wider fifteen (15) pin shape prevents accidental mis-identification and forced insertion of the wrong connector type. Each voltage is transmitted through three grouped together, because the small contacts by themselves cannot supply sufficient current for some devices. A third voltage is supplied, 3.3V, in addition to the traditional 5V and 12V. Each voltage is transmitted through three pins. Five or six pins provide the ground connection, six being standard, or five if staggered spin-up or other special functionality is supported. For each of the three voltages, one of the three pins serves for hot-plugging. The ground pins and power pins 3, 7 and 13 are longer on the plug so they will connect fast. A special hot-plug receptacle can connect ground pins 4 and 12 first. Pin 11 can function for staggered spin-up, activity indication, both or nothing. It is an open collector signal that may be pulled down by the connector or the drive. If pulled down at the connector, the drive spins up as soon as power is applied. If left floating, the drive waits until it is spoken to, this prevents many drives from spinning up simultaneously, which might draw to much power. The pin is also pulled by the drive to indicate drive activity.

There are no alternative variations.

### H. Red Led Light—Left Side

The structure of the led is light emitting diode (70) is to illuminate. The heavy leads help conduct heat away from the chip. The reflector collects light emitted from the edges of the chip. The epoxy is usually colored when the led is a visible light emitter. Light scattering particles are often added to the epoxy. This diffuses the light and causes the end of the led to appear brighter visible light. The function of the red led light is to indicate which hard drive is being used.

Stands for “Light-Emitting Diode”, led is an electronic device that emits light when an electrical current is passed through it. Led are commonly used for indicator lights (such as power on/off lights) on electronic devices. Since led are energy efficient and have a long lifespan (often more than 100,000 hours), they have begun to replace traditional light bulbs in several areas. The energy efficient nature of led allows them to produce brighter light than other types of bulbs while using less energy.

An alternative variation of the led is a different color or shape. And a different voltage can be used.

### I. Green Led Light—Right Side

The structure of the led is light emitting diode (80) is to illuminate. The heavy leads help conduct heat away from the chip. The reflector collects light emitted from the edges of the chip. The epoxy is usually colored when the led is a visible light emitter. Light scattering particles are often added to the epoxy. This diffuses the light and causes the end of the led to appear brighter visible light. The function of the red led light is to indicate which hard drive is being used.

Stands for “Light-Emitting Diode”, led is an electronic device that emits light when an electrical current is passed through it. Led are commonly used for indicator lights (such as power on/off lights) on electronic devices. Since led are energy efficient and have a long lifespan (often more than 100,000 hours), they have begun to replace traditional light bulbs in several areas. The energy efficient nature of led allows them to produce brighter light than other types of bulbs while using less energy.

An alternative variation of the led is a different color or shape. And a different voltage can be used.

### J. Molex (Male) Power Cable

The structure of the Molex power cable (90) is to provide electrical power to on-on miniature bat handle toggle. The function of the Molex power cable is to connect with computer internal power source.

Molex, 21 mm width×6 mm height, as follows (1) yellow+12V, (2) black ground, and (1) red+5V. The pins are 0.200 inches (5.08 mm), apart (center to center). The connector housing has chamfered corners on one side to prevent the user from plugging it in incorrectly. The connector that provides power has male pins and female housing.

There are no alternative variations.

### K. Connections of Main Elements and Sub-Elements of Invention

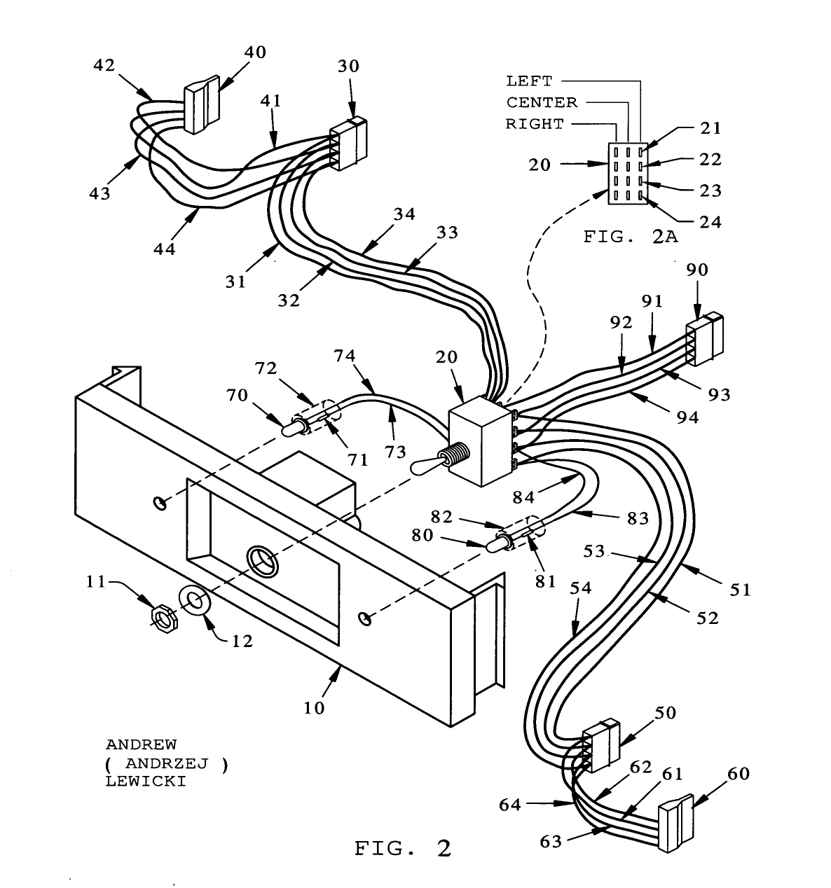

The Molex power cable (90) is connected with on-on miniature bat handle toggle (20) with pin and 20 Gage, 12 inch in length, 5 Volt power cable (91) and center terminal (21), pin and 20 Gage, 12 inch in length, ground cable (92) and center terminal (22), pin and 20 Gage, 12 inch in length, ground cable (93) and center terminal (23), pin and 20 Gage, 12 inch in length, 12 Volt power cable (94) and center terminal (24). See FIG. 2 and FIG. 2A.

The fifteen pin Molex power cable—left side (40) is connected with four pin (female) Molex power cable—left side (30) with 20 Gage, 6 inch in length, 5 Volt power cable (41) and cable (31), 20 Gage, 6 inch in length ground cable (42) and cable (32), 20 Gage, 6 inch in length (33), 20 Gage, 6 inch in length, 12 Volt power cable (44) and cable (34).

Four pin (female) Molex power cable—left side (30) is connected with on-on miniature bat handle toggle (20) with 20 Gage, 12 inch in length, 5 Volt power cable (31) and terminal left (21), 20 Gage, 12 inch in length, ground cable (32) and terminal left (22), 20 Gage, 12 inch in length ground cable (33) and terminal left (23), 20 Gage, 12 inch in length, 12 Volt power cable (34) and terminal left (24).

Red led light—left side (70) is connected with resister (71) 24 Gage, 3 inch in length, 12 Volt power cable (73) with terminal left (24), the other side of red led light (70) is connected with 24 Gage, 3 inch in length, ground cable (74) with terminal left (23). The heat shrink (72) is wrapped red led light (70) and resister (71).

Fifteen pin Molex power cable—right side (60) is connected with four pin (female) Molex power cable—right side (50) with 20 Gage, 6 inch in length, 5 Volt power cable (61) and cable (51), 20 Gage, 6 inch in length, ground cable (62) and cable (52), 20 Gage, 6 inch in length, ground cable (63) and cable (53), 20 Gage, 6 inch in length, 12 Volt power cable (64) and cable (54).

Four pin (female) Molex power-right side (50) is connected with on-on miniature bat handle toggle (20) with 20 Gage, 12 inch in length, 5 Volt power cable (51) and terminal right (21), 20 Gage, 12 inch in length, ground cable (52) and terminal right (22), 20 Gage, 12 inch in length ground cable (53) and terminal right (23), 20 Gage, 12 inch in length 12 Volt power cable (54) and terminal right (24).

Green led light-right side (80) is connected with resister (81), 24 Gage, 3 inch in length, 12 Volt power cable (83) with terminal right (24), the other side of green led light (80) is connected with 24 Gage, 3 inch in length, ground cable (84) with terminal right (23). The heat shrink (82) is wrapped green led light (80) and resister (81).

On-on miniature bat handle toggle (20) is mounted to plastic computer panel (10) thru opening (15) and is held secure with washer (12) and nut (11).

The red led light—left side (70) is mounted thru opening (13) and the green led light—ride side (80) thru opening (14) in the plastic computer panel (10).

### L. Alternative Embodiments of Invention

There are no alternative variations at this time.

### M. Operation of Preferred Embodiment

The user first makes the determination as to serf the internet or to work.

When the decision is made to serf the Internet the user first activates the unit (20) is switched to the left side (changes the direction of electricity). The computer is turn on (activated), the electrical power is provided to unit (90) which provides electrical power to unit (70) is illuminated and electrical power to unit (30), if the hard drive is connected to unit (30) the operating system will start to function. If hard drive is connected to unit (40) the operating system will start to function. Only one hard drive can be used.

Note there are different kinds of hard drives that can be used, ATA or PATA for (30) power cable and SATA or SSD hard drive for (40) power cable.

When the decision is made to work with Autocad, make financial transaction, use word processor or transfer photos from camera to the computer the user first activates the unit (20) is switched to the right side (changes the direction of electricity). The computer is turn on (activated), the electrical power is provided to unit (90) which provides power to unit (80) is illuminated and electrical power to unit (50), if the hard drive is connected to unit (50) the operating system will start to function. If hard drive is connected to unit (60) the operating system will start to function. Only one hard drive can be used.

Note there are different kinds of hard drives that can be used, ATA or PATA for (50) power cable and SATA or SSD hard drive for (60) power cable.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

### INDEX OF ELEMENTS

10: Plastic Computer Panel.
11: Nut
12: Washer
13: 0.13 Inch Dia. Opening
14: 0.13 Inch Dia. Opening
15: 0.25 Inch Dia. Opening
20: On-on Miniature Bat Handle Toggle.
21: Right Terminal, Center Terminal, Left Terminal
22: Right Terminal, Center Terminal, Left Terminal
23: Right Terminal, Center Terminal, Left Terminal
24: Right Terminal, Center Terminal, Left Terminal
30: Four Pin (Female) Molex Power Cable—Left Side.
31: 20 Gage, 12 Inch in Length, 5 Volt Power Cable
32: 20 Gage, 12 Inch in Length, Ground Cable
33: 20 Gage, 12 Inch in Length, Ground Cable
34: 20 Gage, 12 Inch in Length, 12 Volt Power Cable
40: Fifteen Pin Molex Power Cable—Left Side.
41: 20 Gage, 6 Inch in Length, 5 Volt Power Cable
42: 20 Gage, 6 Inch in Length, Ground Cable
43: 20 Gage, 6 Inch in Length, Ground Cable
44: 20 Gage, 6 Inch in Length, 12 Volt Power Cable
50: Four Pin (Female) Molex Power Cable—Right Side.
51: 20 Gage, 12 Inch in Length, 5 Volt Power Cable
52: 20 Gage, 12 Inch in Length, Ground Cable
53: 20 Gage, 12 Inch in Length, Ground Cable
54: 20 Gage, 12 Inch in Length, 12 Volt Power Cable
60: Fifteen Pin Molex Power Cable—Right Side
61: 20 Gage, 6 Inch in Length, 5 Volt Power Cable
62: 20 Gage, 6 Inch in Length, Ground Cable
63: 20 Gage, 6 Inch in Length, Ground Cable
64: 20 Gage, 6 Inch in Length, 12 Volt Power Cable
70: Red Led Light—Left Side.
71: 1,000 Ohm Resister
72: Heat Shrink Tube
73: 24 Gage, 3 Inch in Length, 12 Volt Power Cable
74: 24 Gage, 3 Inch in Length, Ground Cable
80: Green Led Light—Right Side.
81: 1,000 Ohm Resister
82: Heat Shrink Tube
83: 24 Gage, 3 Inch in Length, 12 Volt Power Cable
84: 24 Gage, 3 Inch in Length, Ground Cable
90: Molex (Male) Power Cable
91: 20 Gage, 12 Inch in Length, 5 Volt Power Cable
92: 20 Gage, 12 Inch in Length, Ground Cable
93: 20 Gage, 12 Inch in Length, Ground Cable
94: 20 Gage, 12 Inch in Length, 12 Volt Power Cable

1. THE APPLICANT CLAIMS THE BROADEST POSSIBLE LEGALLY VALID CLAIM FOR THE “ON-ON MASTER SWITCH” AND/OR INVENTION DESCRIBED IN THE ABSTRACT OF THE DISCLOSURE. THE APPLICANT CLAIMS THAT “ON-ON MASTER SWITCH” WILL CHANGE THE WAY COMPUTER OPERATE.
